(19) United States
(12) Patent Application Publication
(10) Pub. No.: US 2003/0056673 A1
(43) Pub. Date: Mar. 27, 2003

(54) Method for producing unobtrusive ornamental visual effects for design configurations and point of reference patterns which enhance the aesthetics and functional criteria of paper and printable substrates

(76) Inventors: John J. Klumpp, Limerick, PA (US); JoAnn Domanski, Kennett Square, PA (US)

Correspondence Address: JACK KLUMPP, Prestige Printing Products, Inc., 107 Landis Creek Lane, Limerick, PA, 19468, US

(21) Appl. No.: 09/957,872

(22) Filed: Sep. 21, 2001

(51) Int. Cl. D21F 11/00; B41C 1/00

(52) U.S. Cl. 101/483

(57) ABSTRACT

Method for producing unobtrusive ornamental visual effects for design configurations and point of reference patterns which enhance the aesthetics and functional criteria of paper and other printable substrates.

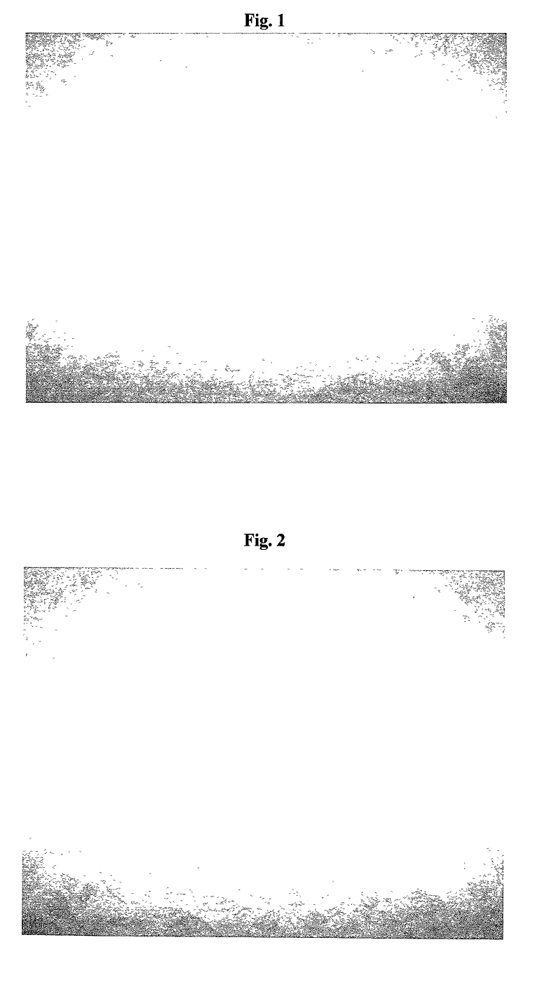

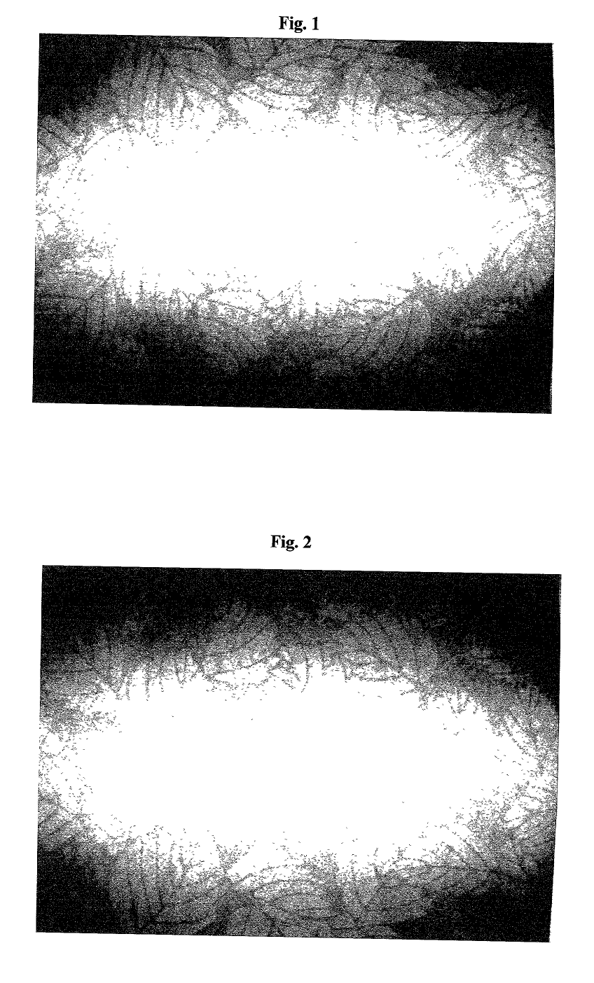

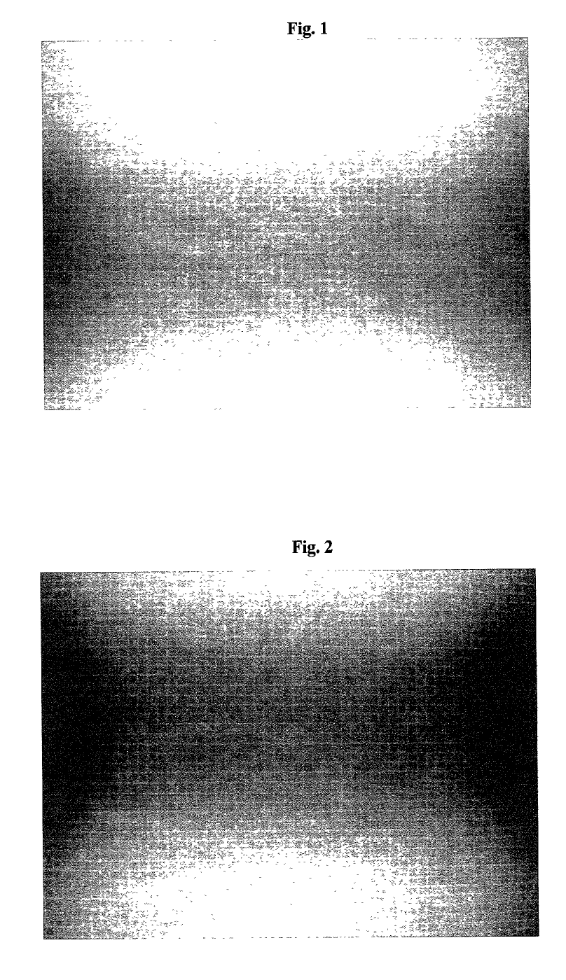

### BACKGROUND OF THE INVENTION

The field of invention is in papermaking and printing. Many methods exist to produce designs and ornamentation on paper. Several methods have been used for producing surface designs on paper: authentic watermarks, chemical watermarks, simulated watermarks, printing ink, embossing and foil stamping. Of the methods mentioned above there are four that superficially resemble the unobtrusive ornamental visual effect, however, this method and article of manufacture qualitatively exceed any of the existing prior art.

The utility of authentic watermarks, chemical watermarks, and simulated watermarks is strictly for security and identification purposes. The methods used to produce authentic watermarks differs greatly from that of chemical watermarks and simulated watermarks. Authentic watermarks are produced in the papermaking process in considerable volumes this disadvantages and other economical considerations led to the development of chemical watermarks and simulated watermarks, all of which provide a common utility of security and identification.

One disadvantage of authentic watermarks is the amount of paper required to meet order requirements. It is a labor intensive process using antiquated dandy rolls with localized wire relief patterns. Watermark wire relief impression patterns lack definition and fidelity. The loss of production and added labor cost in changing these extremely cumbersome dandy rolls contributes to the exorbitant cost for authentic watermark paper.

One disadvantage of Chemical Watermarks & Simulated Watermarks is the migration of ink causing blurred edges. Rigid paper specifications regarding density, thickness, composition and weight of the paper stock when using chemical and simulated watermarks. Stringent machine maintenance is required because the inks must be colorless, any type of pigment or dye would cause this ink to become contaminated.

Printing inks are designed to remain on the surface of paper and other printable substrates. To produce the same ornamental design on the felt side and the wire side of the sheet requires a perfecting press that increases cost.

The disclosures mentioned above deal mainly with antiquated technology and compositions of matter. It is the object of the present invention to teach methods for producing unobtrusive ornamental visual effects for design configurations and point of reference patterns used to enhance the aesthetics and functional criteria of paper and other printable substrates.

### BRIEF SUMMARY OF THE INVENTION

The present invention provides a method and article of manufacture for producing unobtrusive ornamental visual effects for design configurations and point of reference patterns used to enhance the aesthetics and functional criteria of paper and other printable substrates. The unobtrusive ornamental visual effect for design configurations and point of reference patterns of the present invention is formed by eliminating the void volume within the paper or other printable substrate in a desired configuration.

Unobtrusive ornamental visual effects for design configurations and point of reference patterns that enhance the aesthetics and functional criteria of paper and other printable substrates have many uses such as: stationery, envelopes, graph paper, tablet paper, packaging paper, cover stock, and file folder stock.

Authentic watermarks, chemical watermarks and simulated watermarks superficially resemble the unobtrusive ornamental visual effect, however, this method and article of manufacture qualitatively exceed any of the existing prior art.

### DETAILED DESCRIPTION OF THE INVENTION

### FIRST EXAMPLE

A paper or printable substrate such as MICR Bond produced by International Paper. An ink, such as Prestige Printing Product 2029, that can penetrate the paper or printable substrate. This ink has a refractive index of about 1.50. A flexographic printing press designed for either wide or narrow webs. Anilox rolls designed to carry the proper volume of ink to the impression cylinder such as a 120-volume Tri-helic anilox roll. Impression Plates designed to carry the proper volume of ink to the substrate such as Photo-polymer plates screened to 85%. The end effect is to eliminate the void volume in the desired areas. Using a densitometer to check transparency of the article of manufacture, place a black substrate beneath the ornamental or point of reference image and take the reading, this can be compared with the reading where no ornamental or point of reference image design exists. To check color and translucency place a white substrate beneath the ornamental or point of reference image and take the reading this can be compared with the reading where no ornamental or point of reference image design exists. To reproduce consistent image fidelity for quality, the measurements of a selected imaged area on the surface of the paper can be compared with the selected imaged area from the imaged impression plate and image art work. The fact the measurements' fidelity can be compared from the article of manufacture to the impression plate and image art work shows that image fidelity quality is maintained. Any one of these parameters or all of the parameters can be changed or combined to match the base stock, ink, press and printing conditions to achieve the desired visual effect.

### SECOND EXAMPLE

Suitable papermaking equipment to which the present invention relates is a paper machine less than 250″ in width with a maximum production speed of 2,000 ft per minute wherein a laser engraved impression cylinder made of ceramic composite material or suitable durometer rubber is used to produce and image in the 24 pound MICR Bond paper by filling the void volume. This is accomplished by compressing the fibers together eliminating the void volume. Using a densitometer to check transparency of the article of manufacture, place a black substrate beneath the ornamental or point of reference image and take the reading, this can be compared with the reading where no ornamental or point of reference image design exists. To check translucency place a white substrate beneath the ornamental or point of reference image and take the reading this can be compared with the reading where no ornamental or point of reference image design exists. To reproduce consistent image fidelity and quality, the measurements of a selected imaged area on the surface of the paper can be compared with the selected imaged area from the imaged impression cylinder and image art work. The fact the measurements' fidelity can be compared from the article of manufacture to the impression cylinder and image art work demonstrates that image quality and fidelity is maintained. With the advancements in laser engraving technology an impression cylinder can be produced with varying heights in the relief image depending upon the desired ornamental visual effect. Along with the varying heights of the relief on the image cylinder the pressure of the impression cylinder can be varied for the desired ornamental visual effect maintained. Any one of these parameters or all of the parameters can be changed or combined to match the base stock, impression cylinder design, nip pressures and other machine conditions to achieve the desired visual effect.

Modifications of the previously mentioned embodiments will be obvious to those skilled in the art, without departing from the spirit and scope of the invention, as described in the claims.

Having fully disclosed my invention, I claim:

1. Method for producing unobtrusive ornamental visual effects for design configurations and point of reference patterns which enhance the aesthetics and functional criteria of paper and other printable substrates wherein a suitable printing press is used.

2. Method for producing unobtrusive ornamental visual effects for design configurations and point of reference patterns which enhance the aesthetics and functional criteria of paper and other printable substrates wherein a suitable paper machine is used.

3. Method for producing unobtrusive ornamental visual effects for design configurations and point of reference patterns that enhance the aesthetics and functional criteria of paper and other printable substrates as described by claim 2 wherein the dandy roll impression cylinder made of a laser engraved ceramic composite material or suitable durometer rubber to achieve varying degrees of transparence and translucence by filling the void volume that exists within paper and other printable substrates.

4. Method for producing unobtrusive ornamental visual effects for design configurations and point of reference patterns that enhance the aesthetics and functional criteria of paper and other printable substrates as described by claim 1 wherein an ink designed to maintain print quality and penetrate a paper or other printable substrate having a refractive index closely resembling that of paper or other printable substrate.

5. Method for producing unobtrusive ornamental visual effects for design configurations and point of reference patterns that enhance the aesthetics and functional criteria of paper and other printable substrates as described by claim 1 wherein having delivered the desired amount of ink described by claim 4 to achieve varying degrees of transparence and translucence by filling the void volume that exist within paper and other printable substrates.

6. Method for producing unobtrusive ornamental visual effects for design configurations and point of reference patterns that enhance the aesthetics and functional criteria of paper and other printable substrates as described by claim 1 wherein an anilox roller is designed to deliver the proper amount of the ink described by claim 4.

7. Method for producing unobtrusive ornamental visual effects for design configurations and point of reference patterns that enhance the aesthetics and functional criteria of paper and other printable substrates as described by claim 1 wherein an impression roller or plate is designed to deliver the proper amount of the ink described by claim 4.

8. Method for producing unobtrusive ornamental visual effects for design configurations and point of reference patterns that enhance the aesthetics and functional criteria of paper and other printable substrates as described by claim 1 wherein varying degrees of transparency that can be viewed from the wire-side or the felt-side is dependent upon the volume of ink, as described in claim 4, deposited.

9. Method for producing unobtrusive ornamental visual effects for design configurations and point of reference patterns that enhance the aesthetics and functional criteria of paper and other printable substrates as described by claim 1 wherein varying degrees of translucency that can be viewed from the wire-side or the felt-side is dependent upon the volume of ink, as described in claim 4, deposited.

10. Method for producing unobtrusive ornamental visual effects for design configurations and point of reference patterns that enhance the aesthetics and functional criteria of paper and other printable substrates as described by claim 1 wherein varying degrees of color that can be viewed from the wire-side or the felt-side is dependent upon the volume of ink, as described in claim 4, deposited.

11. An article of manufacture that has unobtrusive ornamental visual effects for design configurations and point of reference patterns that enhance the aesthetics and functional criteria of paper and other printable substrates.

12. Process to use a densitometer to measure the transparency as described by claim 11.

13. Process to use a densitometer to measure the translucency as described by claim 11.

14. Process to use a pick glass equipped with a point scale to measure image fidelity as described by claim 11.

15. Any one of these methods or all of the methods can be changed or combined to achieve the desired ornamental visual effects for design configurations and point of reference patterns that enhance the aesthetics and functional criteria of paper and other printable substrates.
